(19) United States
(12) Patent Application Publication
(10) Pub. No.: US 2011/0018867 A1
(43) Pub. Date: Jan. 27, 2011

(54) Video game machine, gaming image display method, gaming image dispaly program and network game system

(75) Inventors: Masakazu Shibamiya, Tokyo (JP); Naonobu Kaneiso, Tokyo (JP)

Correspondence Address: JORDAN AND HAMBURG LLP, 122 EAST 42ND STREET, SUITE 4000, NEW YORK, NY, 10168, US

(73) Assignee: Konami Digital Entertainment Co., Ltd., Minato-ku (JP)

(21) Appl. No.: 12/804,298

(22) Filed: Jul. 19, 2010

(30) Foreign Application Priority Data
Jul. 21, 2009 (JP) 2009-170652

(51) Int. Cl. G09G 5/00; G06T 15/00

(52) U.S. Cl. 345/419; 345/619

(57) ABSTRACT

A video game machine includes a monitor that permits three-dimensional viewing, a virtual camera controller for moving first and second virtual cameras while maintaining a positional relationship in which the two virtual cameras are separated from each other, an image display controller for synthesizing first and second image data acquired by the two virtual cameras upon leading the image data to a display memory, and reading out data content thereof, a game-related image storage block for storing panel images including objects and textures, and a specifier which issues a command for presenting a panel image. The image display controller maps a texture corresponding to an object read out in accordance with the command given from the specifier twice in two storage locations of the display memory that are offset from each other. A player is provided with a gaming image generated with a reduced 3D processing burden, yet creating compelling reality and enjoyable sensation in game playing.

### CROSS REFERENCE

This Nonprovisional application claims priority under 35 U.S.C. §119(a) on Patent Application No. 2009-170652 filed in Japan on Jul. 21, 2009, the entire contents of which are hereby incorporated by reference.

### BACKGROUND OF THE INVENTION

The present invention relates to a video game machine and gaming image display technology which make it possible to present a gaming image with three-dimensional (stereoscopic) effect.

Conventionally, various techniques for presenting a 3D image on a display screen have been proposed. Parallax barrier systems are a commonly known approach to 3D image presentation. 3D display technology includes so-called glass-type display methods that uses a combination of a polarizer or a liquid crystal display (LCD) shutter and viewing glasses as well as parallax panoramagram and lenticular systems which are particularly well-known examples of glasses-free display methods. A technique proposed in recent years is related to a new display method that will make it possible to switch between two-dimensional (2D) and three-dimensional (3D) image displays. Specifically, Japanese Patent No. 3973525 describes a mobile telephone having an LCD panel monitor with a parallax barrier system implemented therein.

Japanese Unexamined Patent Application Publication Nos. 1999-244534 and 1999-250274 each describe a shooting game conducted by use of a plurality of game machines through a network. Also, Japanese Unexamined Patent Application Publication No. 2000-61145 describes an automobile racing game conducted by use of a plurality of game machines through a network. Japanese Unexamined Patent Application Publication Nos. 1999-244534, 1999-250274 and 2000-61145 each disclose an arrangement in which a camera provided in each game machine takes a photograph of a player's face prior to the beginning of a game and, during the course of the game, each game machine presents the photographed facial image of the player close to an image of a character operated by the relevant player, the player's facial image being superimposed side by side with the player's character image on a display screen in a manner that gives a sense of depth.

An apparatus described in Japanese Patent No. 3973525 requires image data for 3D image presentation received by a special mobile telephone, the image data including specially prepared 3D image data contents obtained from a website or an e-mail. Additionally, although this Japanese Patent mentions that the apparatus incorporates a processor which can convert an already available 2D image into 3D image data for stereoscopic viewing, it is only possible to obtain a “simulated” 3D image. Moreover, this Japanese Patent describes only such am arrangement that makes it possible to acquire 3D image data from an external source or to generate a simulated 3D image from a 2D image but contains no mention of a relationship between locations of two cameras.

On the other hand, Japanese Unexamined Patent Application Publication Nos. 1999-244534, 1999-250274 and 2000-61145 focus simply on a technique for presenting each player's facial image superimposed as a 2D image on a two-dimensional gaming image side by side with each player's character.

Although it should technically be possible to generate 3D images on a real-time basis according to manipulation of a controller by a player by employing a parallax barrier system combined with two virtual cameras for left and right eyes that can be moved in a virtual game space, an arrangement capable of this kind of operation will most likely result in an increase in computational throughput and a decrease in processing speed.

### SUMMARY OF THE INVENTION

It is an object of the present invention to provide a video game machine, a gaming image display method and a gaming image display program that make it possible to provide a player with a 3D gaming image obtained by using images captured by a pair of virtual cameras in combination with a panel image which is prepared in advance to permit stereoscopic viewing as presented on-screen, wherein the gaming image is being generated with a reduced 3D processing burden, yet creating compelling reality and enjoyable sensation in game playing.

In one feature of the present invention, a video game machine is configured to present a player with a gaming image captured by at least one virtual camera within a view angle in a viewing direction thereof, the at least one virtual camera forming a combination of first and second virtual cameras having a capability to move within a virtual game space in accordance with manipulation by the player. This video game machine comprises a monitor having a display screen on which a parallax barrier member that permits three-dimensional viewing is provided, a virtual camera controller for moving the first and second virtual cameras while maintaining a positional relationship in which the first and second virtual cameras are separated by a prescribed distance from each other, an image display controller for synthesizing first and second image data acquired by the first and second virtual cameras upon leading the first and second image data to a display memory, and reading out data content of the display memory, a game-related image storage block for storing a plurality of kinds of panel images including objects and textures which are game-related images, and a specifier which issues a command for presenting at least one panel image during execution of a game, wherein the image display controller maps a texture corresponding to an object read out in accordance with the command given from the specifier twice in two storage locations of the display memory that are offset from each other by a specific number of addresses.

In another feature of the present invention, a gaming image display method is intended for a video game machine which comprises a monitor, a virtual camera controller, an image display controller, a game-related image storage block and a specifier, the monitor having a display screen on which a parallax barrier member that permits three-dimensional viewing is provided, the video game machine being configured to present on the monitor a gaming image captured by at least one virtual camera within a view angle in a viewing direction thereof, the at least one virtual camera forming a combination of first and second virtual cameras having a capability to move within a virtual game space in accordance with manipulation of an operating member by a player. This gaming image display control method comprises the steps of causing the virtual camera controller to move the first and second virtual cameras while maintaining a positional relationship in which the first and second virtual cameras are separated by a prescribed distance from each other, causing the image display controller to synthesize first and second image data acquired by the first and second virtual cameras upon leading the first and second image data to a display memory and to read out data content of the display memory, causing the game-related image storage block to store a plurality of kinds of panel images including objects and textures which are game-related images, causing the specifier to issue a command for presenting at least one panel image during execution of a game, and causing the image display controller to map a texture corresponding to an object read out in accordance with the command given from the specifier twice in two storage locations of the display memory that are offset from each other by a specific number of addresses.

In still another feature of the present invention, a gaming image display program is intended for a video game machine which comprises a monitor having a display screen on which a parallax barrier member that permits three-dimensional viewing is provided, the video game machine being configured to present on the monitor a gaming image captured by at least one virtual camera within a view angle in a viewing direction thereof, the at least one virtual camera forming a combination of first and second virtual cameras having a capability to move within a virtual game space in accordance with manipulation of an operating member by a player. This gaming image display program is configured to cause the video game machine to perform functions comprising a virtual camera controller for moving the first and second virtual cameras while maintaining a positional relationship in which the first and second virtual cameras are separated by a prescribed distance from each other, an image display controller for synthesizing first and second image data acquired by the first and second, virtual cameras upon leading the first and second image data to a display memory, and reading out data content of the display memory, a game-related image storage block for storing a plurality of kinds of panel images including objects and textures which are game-related images, and a specifier which issues a command for presenting at least one panel image during execution of a game, wherein the image display controller maps a texture corresponding to an object read out in accordance with the command given from the specifier twice in two storage locations of the display memory that are offset from each other by a specific number of addresses.

According to the video game machine, the gaming image display control method and the gaming image display program of the invention thus configured, a parallax barrier member that permits three-dimensional viewing is provided on the display screen of the monitor so that the player can the gaming image with a three-dimensional effect. Each virtual camera moves within the virtual game space in accordance with manipulation by the player. As the gaming image presented to the player on the monitor within the view angle in the viewing direction of each virtual camera, the player can move each virtual camera by manipulating an operating member while observing the on-screen gaming image. The virtual camera controller moves the first and second virtual cameras while maintaining a positional relationship in which the two virtual cameras are separated by a prescribed distance from each other in accordance with manipulation by the player. The image display controller synthesizes the first and second image data acquired by the first and second virtual cameras upon leading the first and second image data to the display memory and reads out the data content of the display memory and transmits the same to the monitor. Consequently, the monitor presents the gaming image captured by the first and second virtual cameras with the three-dimensional effect on a real-time basis. Also, the game-related image storage block stores a plurality of kinds of panel images including objects and textures which are game-related images. When the specifier issues a command for presenting at least one panel image during execution of a game, the image display controller generates a texture corresponding to an object read out in accordance with the command given from the specifier twice at locations offset from each other by a specific number of addresses, the texture are mapped twice in two storage locations of the display memory that are offset from each other. It follows that there is obtained a pair of panel images for the left and right eyes. Since the panel images are written in the display memory, overwriting the first and second image data acquired by the first and second virtual cameras which have already been written in the display memory, in the aforementioned manner, gaming images captured by the first and second virtual cameras and the previously prepared panel images are presented together on the same display screen of the monitor with a three-dimensional effect although in different ways.

In a gaming image displayed on-screen, objects to be presented are divided into two categories, that is, those objects whose appearance dynamically vary in accordance with manipulation of a controller by the player and those objects (e.g., objects, voice messages, pictograms, etc. displayed in a specific image) whose appearance do not dynamically vary. If the objects which do not vary dynamically are displayed in the form of virtual display panels arranged side by side representing images obtained by the left and right eyes together with previously offset textures, then it is possible to present the gaming images without jeopardizing the three-dimensional effect, yet preventing an increase in memory capacity required for generating three-dimensional images. Thus, it is possible to provide the player with gaming images producing compelling reality and enjoyable sensation in game playing with a reduced 3D processing burden.

These and other objects, features and advantages of the invention will become more apparent upon a reading of the following detailed description in conjunction with the accompanying drawings.

### BRIEF DESCRIPTION OF THE DRAWINGS

FIG. 1 is a general configuration diagram of a game system according to an embodiment of the invention;

FIG. 2 is a perspective diagram illustrating the external appearance of a gaming terminal according to the embodiment;

FIG. 3 is a hardware configuration diagram of the gaming terminal according to the embodiment;

FIG. 4 is a functional configuration diagram of a control section of the gaming terminal;

FIG. 5 is a hardware configuration diagram of a server according to the embodiment;

FIG. 6 is a functional configuration diagram of a control section of the server;

FIG. 7 is a diagram for explaining how each virtual camera moves in relation to movements of a player's own character;

FIG. 8 is a diagram for explaining a state in which the player's own character has assumed an attacking posture;

FIGS. 9A and 9B are schematic diagrams for explaining a principle of 3D display mode applied to a gaming image, FIG. 9A illustrating a relationship between a pair of virtual cameras and a subject and FIG. 9B illustrating a relationship between images captured by the pair of virtual cameras and an image displayed on a monitor;

FIG. 10 is a configuration diagram illustrating an arrangement for displaying the gaming image in the 3D display mode;

FIG. 11 is a diagram depicting an exemplary gaming image displayed on-screen during a shooting game;

FIG. 12 is a flowchart illustrating a game processing procedure carried out by a central processing unit (CPU) of the gaming terminal according to a game program; and

FIG. 13 is a flowchart illustrating a panel image display processing procedure carried out by the CPU of the gaming terminal according to the game program.

### DETAILED DESCRIPTION OF THE INVENTION

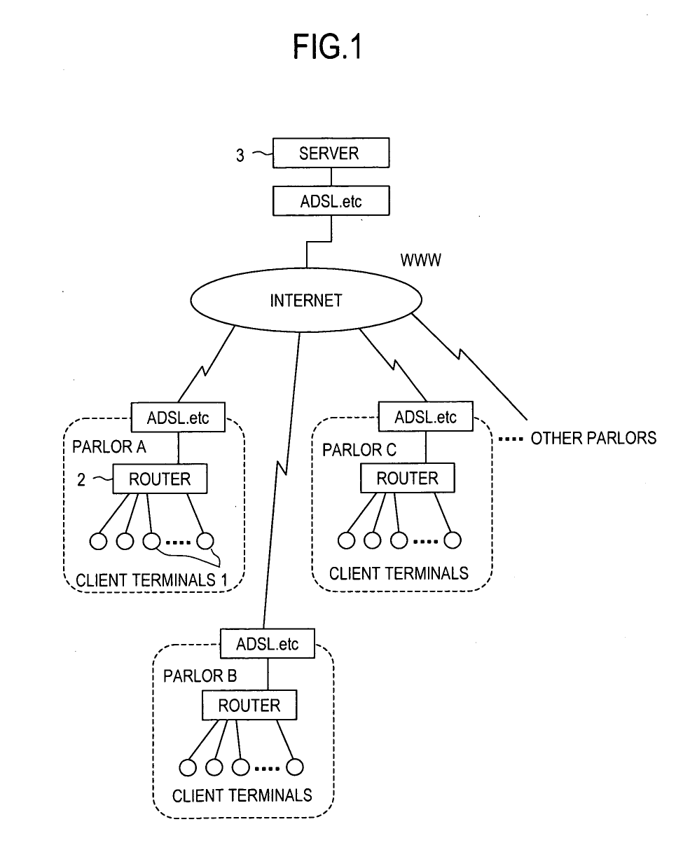

FIG. 1 is a configuration diagram of a competitive game system employing video game machines according to an embodiment of the present invention. The competitive game system comprises a plurality of (8 in this embodiment) client terminal apparatuses (gaming terminals) 1 to which identification information is individually assigned, routers 2 each of which is a communication device communicatably connected to the individual gaming terminals 1 provided in one arcade game parlor and to gaming terminals 1 provided in other arcade game parlors to enable communication therebetween over a network (i.e., the Internet), and a server 3 communicatably connected to the individual gaming terminals 1 through the routers 2 for managing information concerning player authentication, player selection and game histories that allow a plurality of players to play at the respective gaming terminals 1.

Each of the gaming terminals 1 allows a player to proceed with a game by performing prescribed operations while watching a game screen presented on a monitor 11. The identification information assigned to each of the gaming terminals 1 includes identification information assigned to the router 2 to which the gaming terminals 1 are connected (or identification information assigned to an arcade game parlor where the gaming terminals 1 are located) and identification information (i.e., a terminal number) assigned to each of the gaming terminals 1 located in the arcade game parlor. For example, if the identification information assigned to arcade game parlor A is “A” and the identification information assigned to a particular gaming terminal 1 in arcade game parlor A is “4”, then the identification information given to that gaming terminal 1 is “A4”.

Each of the routers 2 is communicatably connected to the plurality of gaming terminals 1 provided in one arcade game parlor and to the server 3 to permit transmission and reception of data between the gaming terminals 1 and the server 3.

The server 3 which is communicatably connected to each of the routers 2 stores player information in association with user identification codes (user IDs) used for identifying individual players and serves to select players (opponents) who will play a game in a common game space with a primary player at any one of the gaming terminals 1 by transmitting and receiving data to and from the gaming terminals 1 through the respective routers 2.

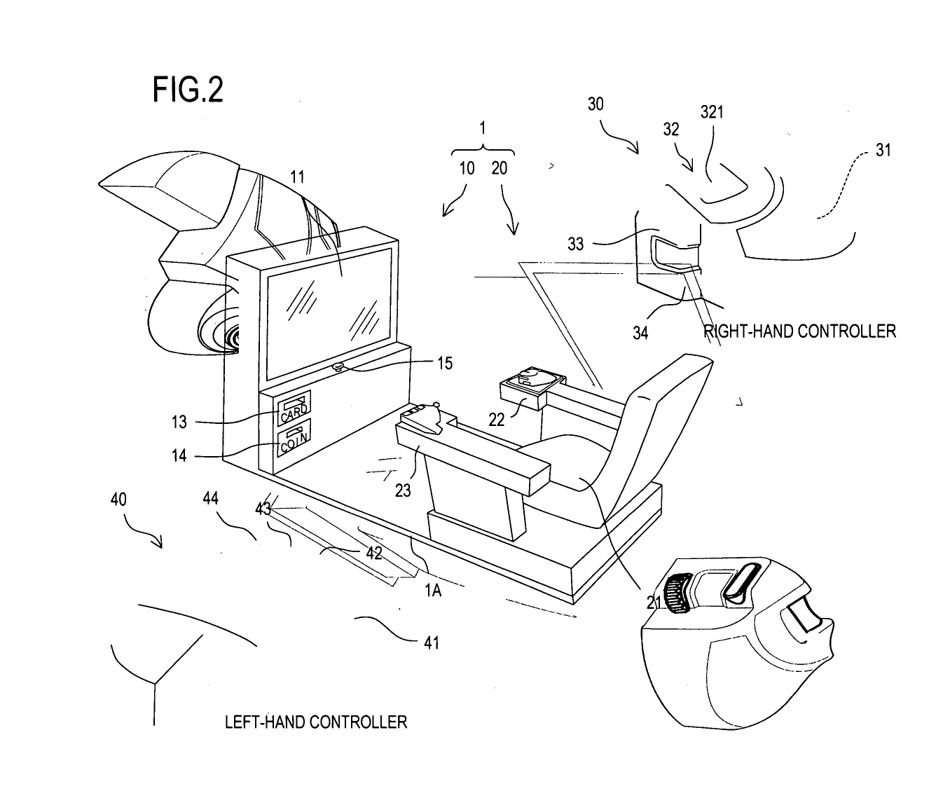

FIG. 2 is a perspective diagram illustrating the external appearance of one of the gaming terminals 1 according to the embodiment. In the following discussion of the present embodiment, it is assumed that each competitive game played by use of the gaming terminals 1 is a simulated shooting game. The gaming terminals 1 are configured to allow a choice of single (one-to-one) fighting mode and group fighting mode. In the group fighting mode, each game is played by specified numbers of friend and foe players (e.g., 2 or 4 players on each side). In either of the single fighting mode and the group fighting mode, each gaming terminal 1 exchanges data concerning operations performed by the individual players with the other gaming terminals 1 through a later-described network communication section 18 and the router 2.

The gaming terminal 1 has a monitor section 10, a controller section 20 located in front of the monitor section 10 and a mat member 1A joining the monitor section 10 and the controller section 20 to each other. The monitor section 10 includes the aforementioned monitor 11 which is made of an LCD display, a plasma display or the like for presenting a gaming image, a card reader 13 that reads contents of a user card, a coin input section 14 that accepts coins (gaming fee) placed therein and a pushbutton 15 or the like used for selecting a desired display mode as will be discussed later. The aforementioned user card is a magnetic card or an integrated circuit (IC) card storing player identification information in the form of a user ID. Although not illustrated in FIG. 2, the gaming terminal 1 is also provided with a speaker 12 for producing sound effects in the event of the player's offensive action (e.g., shooting), for instance.

The controller section 20 of this embodiment includes a chair-like seat 21 provided with a right-hand armrest 22 and a left-hand armrest 23. The right-hand armrest 22 and the left-hand armrest 23 have at forwardmost ends thereof a first control pad 30 and a second control pad 40, respectively, each having a comfortably grippable size. More specifically, upper forwardmost portions of the right-hand armrest 22 and the left-hand armrest 23 are shaped to form flat surfaces, and the first and second control pads 30, 40 are disposed on the respective upper flat surfaces.

The first control pad 30 includes a built-in optical mouse 31 on the bottom of the first control pad 30, a trigger button 32 on an upper surface, an attitude changing button 33 at an upper part of a side surface and a jog dial 34 just below the posture changing button 33, wherein the trigger button 32 and the posture changing button 33 serve as pushbutton switches. The optical mouse 31 has a conventionally known structure and functions as a sliding distance detector. Specifically, the first control pad 30 incorporates a light emitter for projecting illuminating light to the exterior through an illuminating aperture formed in part of a bottom plate of the first control pad 30 and an imaging device for imaging the exterior upon receiving light reflected therefrom. The first control pad 30 determines the amount of movement thereof by sensing a change in an external image picked up by the imaging device. The upper forwardmost portion of the right-hand armrest 22 is formed to have a prescribed surface roughness so that the change in the image picked up by the imaging device can be properly detected. The optical mouse 31 is configured to have the capability to measure sliding distances in front, rear, left and right directions when the first control pad 30 is slid along the upper surface of the right-hand armrest 22.

When a movable part 321 of the trigger button 32 is depressed inward, an unillustrated internal movable metal piece thereof goes into contact with an unillustrated stationary metal piece and generates an electrical signal which is used for sensing the player's depression of (clicking on) the trigger button 32. Such a mouse click by the player serves to enter a command for a shooting action to be performed by his or her own character presented on a display screen of the monitor 11.

The posture changing button 33 has a structure that is swingable in a horizontal plane with one end of the posture changing button 33 biased to stick outward. Each time this outwardly sticking end of the posture changing button 33 is depressed against a biasing force, the player's character is caused to assume a squatting position. The jog dial 34 is used for setting the panning rate of two virtual cameras 60. Each virtual camera 60 is caused to pan at a speed corresponding to the amount of rotation of the jog dial 34.

The second control pad 40 includes a joystick 41 used for entering a command for moving the player's own character, a posture button 42, an item button 43 and an action button 44, the item button 43 and the action button 44 being pushbutton switches located at an outer front part of the second control pad 40. The individual buttons 42, 43, 44 have essentially the same mechanical structure as the above-described trigger button 32. The joystick 41 has a conventionally known structure provided with a control stick tiltable in any desired direction in a horizontal plane and is configured to transmit a signal indicative of the direction and angle of tilt of the control stick. The signal indicative of the tilt direction and tilt angle of the control stick is for entering a command for moving the player's own character in a virtual game space presented on the display screen of the monitor 11, the tilt angle specifying a moving speed of the character and the tilt direction specifying a moving direction thereof. While the moving direction of the player's own character may be one of directions throughout 360 degrees, the moving direction is set to fall within specific limited ranges of directions including front, rear, left and right directions for reasons related to signal processing. For example, there are 8 ranges of directions within which the moving direction of the character should fall. The present embodiment may be modified to employ an arrangement in which the player's own character alternately stops and moves or, alternatively, an arrangement in which the character's moving speed is set in prescribed discrete steps (e.g., two steps) regardless of the tilt angle of the joystick 41 that is originally intended to specify the moving speed.

The posture button 42 functions as a ready-to-attack command input member. When depressed by the player, the posture button 42 enters a command for initiating a preparatory operation in which one of weapons possessed by the player's own character is prepared ready to perform an intended function. The item button 43 is performing an operation for varying the choice of a desired one of a plurality of predefined items (simulated weapons in this embodiment). Typically, successive depressions of the item button 43 allow the player to cyclically select one item after another. The items prepared for selection by the player will include simulated weapons appropriate for playing the competitive game, such as virtual guns like a rifle and a handgun, other kinds of hand-operated weapons like a knife and a hand grenade, etc. When a desired item (simulated weapon) is specified by the player, the player's own character will hold the weapon in the form of a virtual image in one hand as presented on the display screen of the monitor 11. In a case where a variety of items are presented as options on-screen, the player may perform an operation for choosing a desired item by using the item button 43 as will be discussed later in detail. For example, the player may enter a command for choosing a desired item by using the item button 43 in combination with another button or, alternatively, by operating the item button 43 in a way different from the operation performed when varying the choice of a desired item, such as by double-clicking the item button 43, in order that the operations for choosing and varying the desired item can be differentiated from each other. The action button 44 functions as an “Action!” command input member that is used for initiating a martial art combat at close range (infighting), for example.

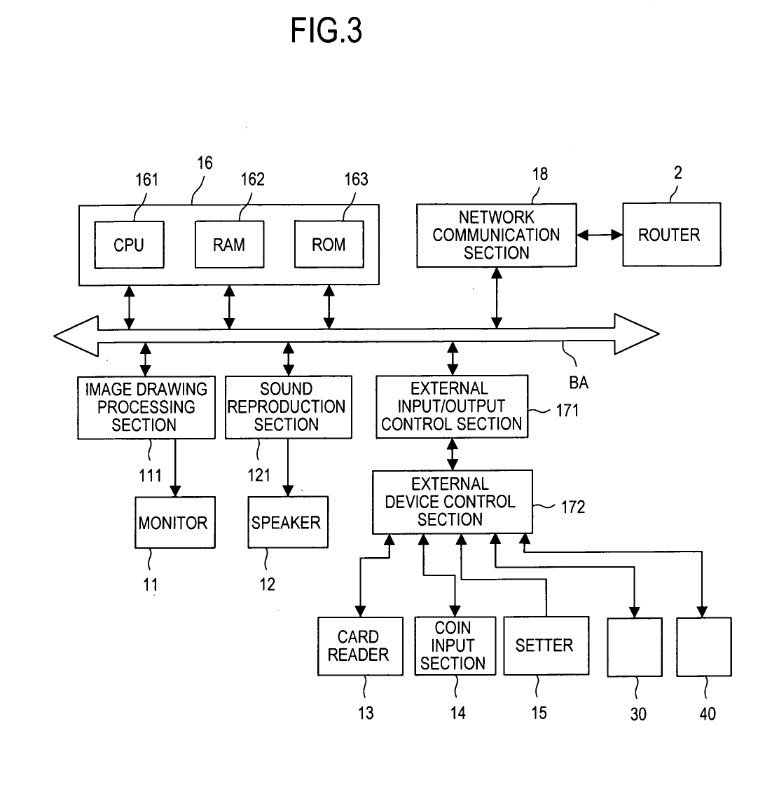

At an appropriate location within the gaming terminal 1, there is provided a control section 16 (refer to FIG. 3) including a microcomputer or the like which receives sensing signals and outputs control signals to individual parts.

FIG. 3 is a hardware configuration diagram of the gaming terminal 1 according to the present embodiment. The control section 16 which performs overall control of the gaming terminal 1 includes a CPU 161 serving as an information processor for carrying out operations related to the progress of each game, an image display operation and various other information processing operations, a random access memory (RAM) 162 for temporarily storing in-process information, for instance, and a read-only memory (ROM) 163 in which prescribed image information and a game program, for instance, are stored in advance.

Referring to FIG. 3, an external input/output control section 171 converts the sensing signals input from a sensing section including such devices as the card reader 13 and the coin input section 14 into digital signals which can be processed by the control section 16. The external input/output control section 171 also converts command information into control signals and outputs the control signals to the respective devices of the sensing section. The external input/output control section 171 is configured to perform such signal processing and input/output operations in a time-divisional fashion, for example. Additionally, the external input/output control section 171 transmits command information corresponding to individual operations on the pushbutton 15 and the first and second control pads 30, 40 to the control section 16. An external device control section 172 performs operations for outputting the control signals to the individual devices of the sensing section and inputting the sensing signals from the individual devices of the sensing section during time slots respectively allocated in a time division scheme.

An image drawing processing section 111 including a video RAM and the like serves to draw and present a prescribed image on the monitor 11 according to an image display command fed from the control section 16. A sound reproduction section 121 serves to create prescribed audible messages and/or background music, for instance, and output the same to the speaker 12 according to a command fed from the control section 16.

The ROM 163 stores such image elements as specified numbers of friend and foe characters (e.g., 4 characters on each side), predefined items (simulated weapons), background images and various kinds of screen image elements, for example. Each of the image elements is constructed of a specified number of polygons so that these image elements can be drawn three-dimensionally. According to an image drawing command fed from the CPU 161, the image drawing processing section 111 performs such mathematical operations as conversion from a world coordinate system defined in a three-dimensional space (virtual game space) to a local coordinate system referenced to the position of the virtual camera pair 60, calculation for converting positions in the local coordinate system into positions in a virtual three-dimensional space, and calculation for defining a light source location. The image drawing processing section 111 further performs operations (i.e., rendering and mapping operations) for writing image data used for drawing the image elements in the video RAM, such as an operation for writing (pasting) texture data in an area of the video RAM defined by polygons, for example, based on the results of the aforementioned calculations. Image elements prepared for use in a background may include various kinds of objects which are suited for applications in a shooting game, such as ruined factories, outdoor scenes (e.g., buildings and streets in urban areas, in-forest scenes), and the like. The ROM 163 stores game-related information (i.e., panel images), image data concerning phrases of voice messages and item image data, for example, as will be further discussed later.

Now, a relationship between the working of the CPU 161 and the working of the image drawing processing section 111 is discussed. The CPU 161 reads out image, sound and control program data as well as game program data prepared according to a predefined game rule from the ROM 163 under the control of an operating system (OS) recorded in the ROM 163 which may be of a built-in or removable type that can be removed from and inserted into an image display processing section for outputting the image information and displaying the same on the monitor 11. Part or all of the image, sound and control program data thus read is held in the RAM 162. Thereafter, the CPU 161 performs processing operations according to a control program held in the RAM 162, various kinds of data (i.e., the image data including data on polygons representing objects displayed on-screen, a texture and character data as well as the sound data) and the sensing signals fed from the sensing section.

Among various kinds of data stored in the ROM 163, data stored in a removable storage medium may be made readable by such a drive as a hard disk drive, an optical disc drive, a flexible disk drive, a silicon disk drive or a cassette medium reading device, for example. In this case, a suitable storage medium is a hard disk, an optical disc, a flexible disk, a compact disc (CD), a digital versatile disc (DVD) or a semiconductor memory, for example.

The aforementioned network communication section 18 of the gaming terminal 1 performs transmission and reception of operational information occurring during execution of a shooting game concerning operations performed by the primary player playing at the gaming terminal 1 to and from the other gaming terminals 1 operated by the friend and foe players through the respective routers 2, and through the network. The network communication section 18 also performs transmission and reception of information obtained in a process of accepting a new player and game scoring information available at a point of completion of each game to and from the server 3 through the relevant router 2, for example.

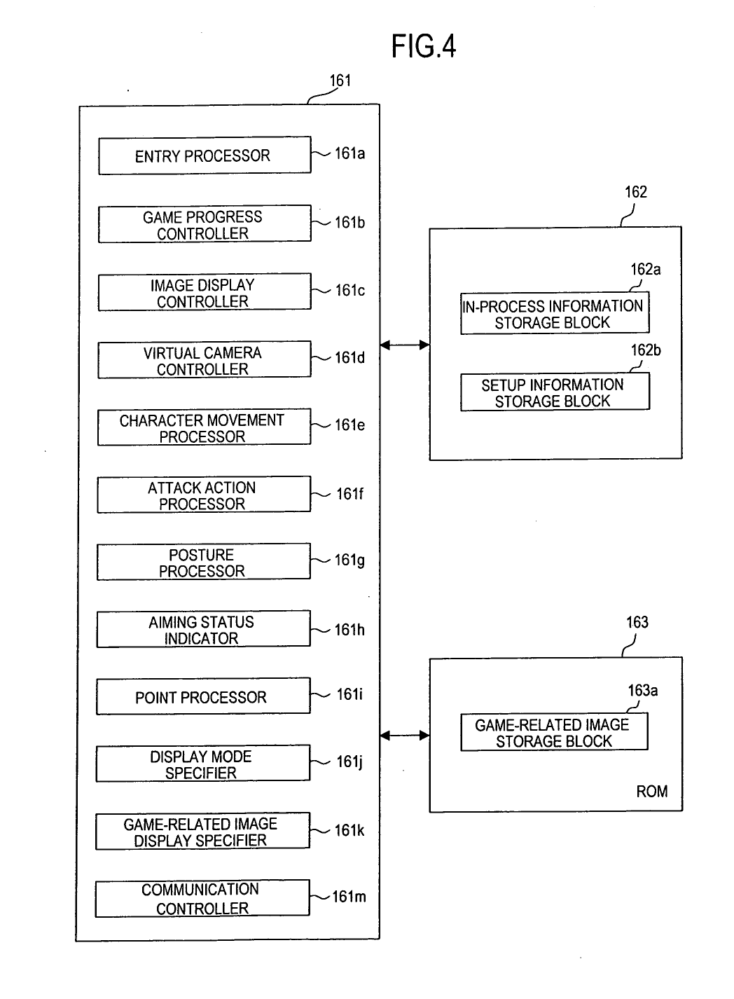

FIG. 4 is a functional configuration diagram of the control section 16 of the gaming terminal 1. By executing the game program and the control program held in the RAM 162, the CPU 161 serves as a plurality of functional blocks including an entry processor 161a which performs an operation for accepting the entry of each player into a shooting game, a game progress controller 161b which causes the shooting game to proceed while controlling the progress thereof all the way from a starting point to an ending point of the shooting game, and an image display controller 161c which controllably provides an on-screen presentation of such images as an entry screen image and a gaming image on the monitor 11. The functional blocks of the CPU 161 activated by executing the game program and the control program held in the RAM 162 further includes a virtual camera controller 161d which controls the position and viewing direction of each virtual camera 60, a character movement processor 161e which processes movement of the player's own character in the virtual game space, an attack action processor 161f which processes each attack action performed by the player's own character using a weapon held thereby in the form of a virtual image, a posture processor 161g which controls a posturing action performed in advance of an attack action in preparation therefor, an aiming status indicator 161h which serves to present the status of aiming including a shooting direction during execution of the posturing action, a point processor 161i which processes points concerning attacks on any foe character by the primary player's character and on the primary player's character by any foe character, a display mode specifier 161j which issues a command to switch between 2D display mode and 3D display mode as will be described later, a game-related image display specifier 161k which issues a command and performs operation for presenting information related to the game during the progress thereof, and a communication controller 161m which controls exchanges of various kinds of information.

The entry processor 161a accepts the entry of a new player when the player inserts his or her user card into the card reader 13 of the gaming terminal 1. The entry processor 161a then reads the user ID from the user card and transmits the read user ID to the server 3. In a case where a plurality of fighting modes are available, a desired fighting mode can be selected by depressing the joystick 41 or a switch or a button whichever specified, for example.

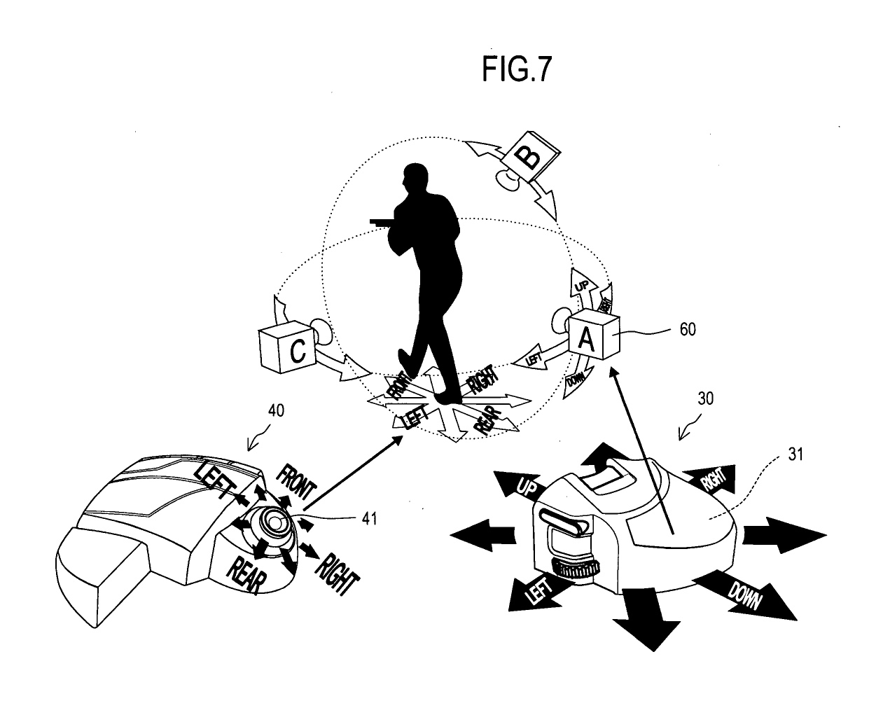

The virtual camera controller 161d serves to adjust the viewpoint and viewing direction of each virtual camera 60 when the optical mouse 31 is manipulated according to details of manipulation. The virtual camera controller 161d sets the position of each virtual camera 60 in terms of a relative positional relationship with the player's own character. In this invention, the gaming terminal 1 is provided with the two virtual cameras 60, which may hereinafter be referred to as the virtual cameras 60L and 60R where necessary, to enable 3D image presentation as will be described later in detail. A detailed description of how these virtual cameras 60L, 60R move when the optical mouse 31 is manipulated will also be provided later with reference to FIG. 7.

The character movement processor 161e serves to adjust the moving speed and direction of the player's own character when the joystick 41 is manipulated according to details of manipulation. The virtual camera controller 161d controls the virtual cameras 60 in such a manner that, when the player's own character moves, the viewpoint of each virtual camera 60 moves in parallel with the moving player's own character. This makes it possible to maintain the relative positional relationship between the viewpoint of the player's own character and surrounding objects and present the gaming image showing the correctly located surrounding objects. The gaming image presented on the monitor 11 by the image display controller 161c reflects the result of processing by the character movement processor 161e.

FIG. 7 is a diagram for explaining how each virtual camera 60 moves in relation to movement of the player's own character. Referring to FIG. 7, when the first control pad 30 (optical mouse 31) is slid along a front-rear (up-down) direction, the optical mouse 31 measures the amount of mouse sliding (sliding distance) and causes the virtual camera pair 60 to pan by an angle corresponding to the measured sliding distance. If the virtual camera pair 60 is currently at a position marked by “A” (FIG. 7) and the optical mouse 31 is slid frontward, for example, the virtual camera pair 60 is caused to pan in a direction toward a position marked by “B” (FIG. 7) by an angle corresponding to the sliding distance. On the contrary, if the optical mouse 31 is slid rearward, the virtual camera pair 60 currently at the “A” position is caused to pan in a direction toward a position marked by “C” (FIG. 7) by an angle corresponding to the sliding distance. Also, if the virtual camera pair 60 is currently at the “A” position and the optical mouse 31 is slid leftward or rightward, then the virtual camera pair 60 is caused to pan in a leftward or rightward direction in a horizontal plane by an angle corresponding to the sliding distance. The virtual camera controller 161d pans each virtual camera 60 according to the direction and distance of sliding of the optical mouse 31 by the player and, as a consequence, the image display controller 161c presents an image showing every object located within a prescribed view angle of each virtual camera 60 in the viewing direction thereof. Accordingly, the gaming terminal 1 operated by each player presents a gaming image containing objects centered around the relevant player on the monitor 11 even in the case of a group shooting game played in a common virtual game space.

Additionally, when the control stick of the joystick 41 is tilted in one direction (front, rear, left, right or else) by a specific angle, the joystick 41 outputs an electrical signal corresponding to the direction and angle of tilt of the control stick to the character movement processor 161e. Based on this electrical signal, the character movement processor 161e causes the player's own character to move at a velocity corresponding to the joystick tilt direction and angle. The moving direction of the player's own character is determined with reference to a current facing direction of the player's own character. FIG. 7 shows an example in which the player's own character is going to move forward. Moving the player's own character in a desired direction by manipulating the joystick 41, the player can cause his or her own character to approach a foe character or retreat and thereby proceed with the game advantageously. Moreover, by operating the optical mouse 31 while manipulating the joystick 41 to move his or her own character, the player can move his or her own character more properly while checking objects surrounding his or her own character.

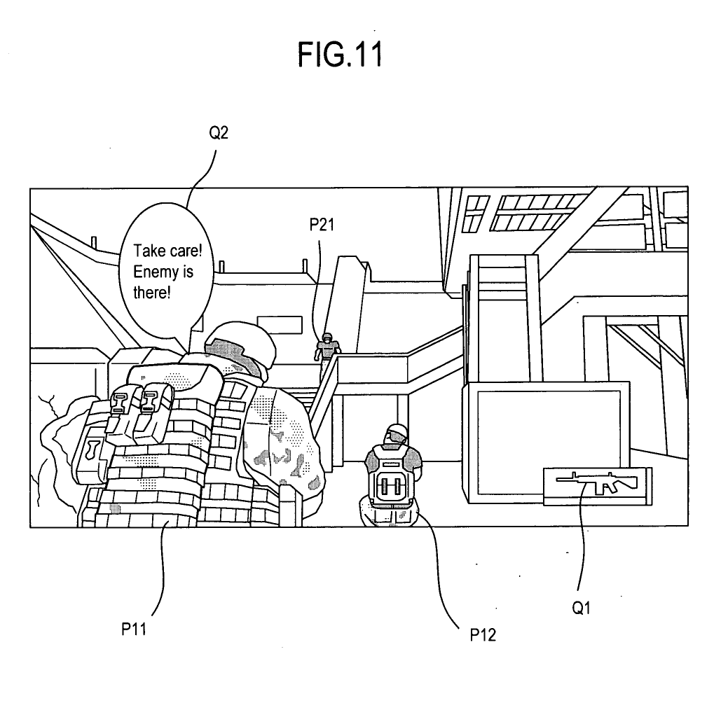

Upon sensing a depression of the trigger button 32, the attack action processor 161f causes the player's own character to attack a foe character with a virtual weapon available at hand. The posture processor 161g directs the player's own character in the prescribed viewing direction of each virtual camera 60 when the posture button 42 is depressed. Specifically, the posture processor 161g serves to make the direction of the virtual weapon (e.g., a barrel thereof) possessed by the player's own character coincide with or become parallel to the viewing direction of each virtual camera 60. Meanwhile, there is a choice of third person shooter (TPS) display mode and first person shooter (FPS) display mode in determining the viewpoint of each virtual camera 60. The viewpoint of each virtual camera 60 is set at a position obliquely behind a specified part of the player's own character (e.g., an upper part of the character body) in the TPS display mode, whereas the viewpoint is set at a face position of the player's own character or at the position of the virtual weapon in the FPS display mode. When the posture button 42 is depressed, the position of each virtual camera 60 is controlled in the TPS display mode. In this case, the virtual camera controller 161d sets the viewpoint (and thus the viewing direction) of each virtual camera 60 to generally coincide with the player's own character (i.e., at an “over-the-shoulder” position) and, therefore, the center of the display screen of the monitor 11 corresponds to the “over-the-shoulder” position of the player's own character (refer to FIG. 11, for example).

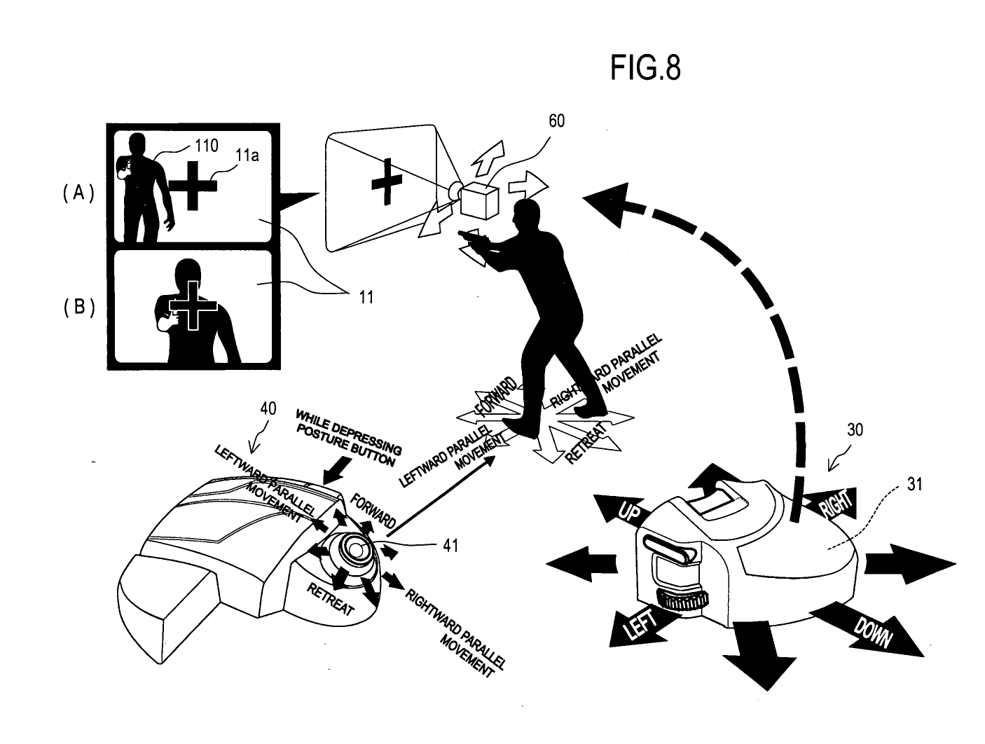

FIG. 8 is a diagram for explaining a state in which the player's own character has assumed an attacking posture. As illustrated in FIG. 8, the virtual camera pair 60 is aimed generally frontward. If the posture button 42 is depressed in this condition, the barrel of the virtual weapon is aimed in a frontward direction which matches the viewing direction of each virtual camera 60 regardless of the facing direction of the player's own character. FIG. 8 contains at left pictures (A) and (B) in which the player's own character assumes an attacking posture, holding the virtual weapon (handgun object) aimed forward. Both of these pictures (A), (B) show images illustrated in the FPS display mode, each image containing an aiming mark 11a shown at the center of the display screen representing a point at which the barrel of the virtual weapon is aimed. The aiming status indicator 161h serves to present the on-screen aiming mark 11a in association with the posture processor 161g. In picture (A), the aiming mark 11a is off a foe character 110 and, therefore, the player's own character will miss the foe character 110 even if the player depresses the trigger button 32 in this state. Thus, the player may slide the optical mouse 31 leftward by a specific amount so that the aiming mark 11a shifts relatively leftward and overlies the foe character 110 as shown in picture (B). To be more specific, the player is to slide the optical mouse 31 leftward from the state shown in picture (A) so that the foe character 110 is shifted rightward (relative to the aiming mark 11a) until the foe character 110 comes to the center of the display screen of the monitor 11 where the aiming mark 11a overlies the foe character 110. The player's own character can hit the foe character 110 if the player depresses the trigger button 32 in this state.

The attack action processor 161f may calculate the trajectory of a bullet ejected from the barrel of the virtual weapon and present the trajectory on-screen according to the result of calculation, or the present embodiment may employ an arrangement in which the bullet will pass through a circle having a specific diameter (or a specified area) centered around a central point of the cross-shaped aiming mark 11a in an imaginative fashion. With this arrangement employed, it is judged that the foe character 110 has been successfully hit if part of the foe character 110 overlies the aforementioned specified area. It is to be noted, however, that the bullet does not necessarily proceed toward the central point of the cross-shaped aiming mark 11a. Thus, the attack action processor 161f may perform a processing operation for simulating an irregular vibratory motion of a barrel of a machine gun or the like or a processing operation for simulating a situation in which the virtual weapon irregularly goes off an intended shooting direction while the player's own character is in motion, for example.

The point processor 161i is configured to accumulate a prescribed number of points for the player in the event of a successive attack on the foe character 110, or at each successive target shot, for example. The point processor 161i may be configured to calculate the sums of the accumulated points separately for friend and foe sides at a game ending point to allow a decision on victory or defeat depending on which side has gained a larger number of points. The point processor 161i may additionally be configured such that the player's own character assumes a “hit-down” pose for a specific period of time when hit by another player, and the player is prohibited from entering any command that causes the player's own character to move or attack. Alternatively, the point processor 161i may be configured such that the player's own character is assigned a specific “life value” at a game starting point and loses the life value in decremental steps each time the player's own character is hit by another player. Once the player's life value has become zero, the player's own character will be prohibited from returning to the game, which means only that player will receive a forced “game over” declaration.

The display mode specifier 161j issues a command for automatically switching between the 2D display mode and the 3D display mode in accordance with the player's manipulation of the pushbutton 15 or by sensing whether the game currently in progress has reached a prescribed situation, in which the player has begun to assume a shooting pose, for example, or the game has returned to an initial situation. The 2D display mode is a method of directly presenting a 3D image with no three-dimensional (stereoscopic, or 3D) effect. In contrast, the 3D display mode is a method of presenting a 3D image with the 3D effect by leading images having parallax for left and right eyes to the respective eyes to re-create the 3D image with stereopsis achieved when viewed by the left and right eyes.

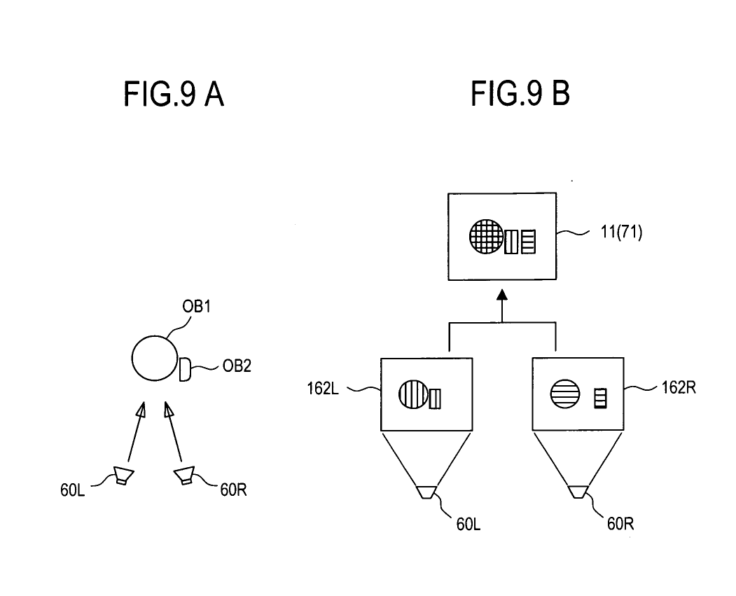

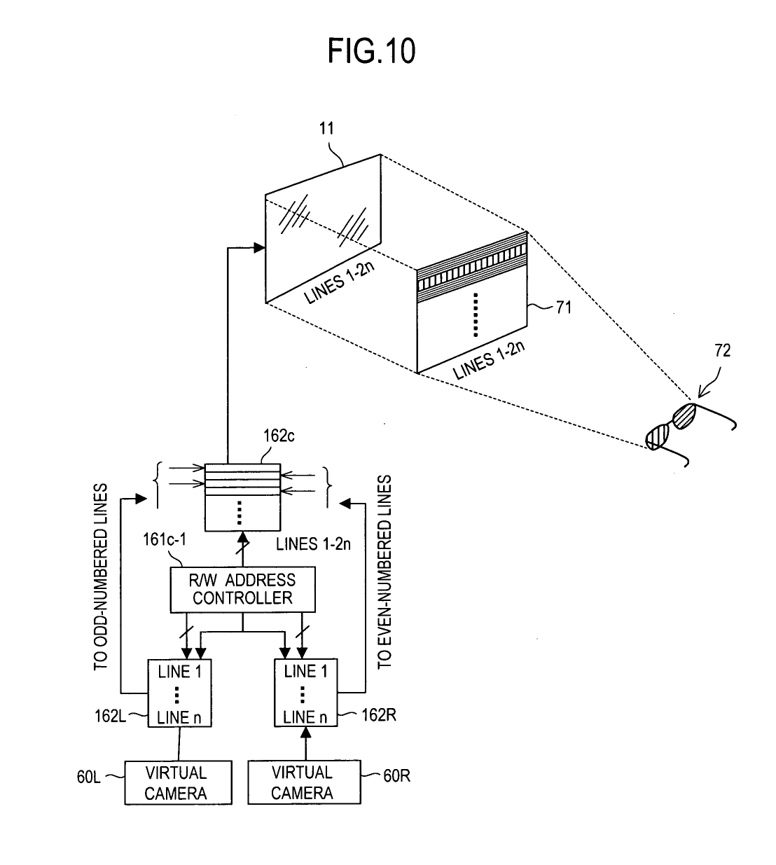

FIGS. 9A and 9B are schematic diagrams for explaining a principle of the 3D display mode applied to a gaming image, FIG. 9A illustrating a relationship between the pair of virtual cameras 60L, 60R and a subject and FIG. 9B illustrating a relationship between images captured by the pair of virtual cameras 60L, 60R and an image displayed on the monitor 11. FIG. 10 is a configuration diagram illustrating an arrangement for displaying the gaming image in the 3D display mode.

As illustrated in these Figures, there are provided the virtual cameras 60L and 60R which correspond to the left and right human eyes, respectively, in the virtual game space. The two virtual cameras 60L, 60R have a prescribed positional relationship with viewing directions thereof intersecting at a specific position in a depthwise direction. Typically, the viewing directions of the two virtual cameras 60L, 60R intersect at the position of a character or an object, each being a subject located in the virtual game space. An image storage block 162L is a memory area defined in one part of the RAM 162 where image data for one scene captured by the image storage block 162L in the virtual game space is written. An image storage block 162R is a memory area defined in another part of the RAM 162 where image data for one scene captured by the image storage block 162R in the virtual game space is written. Objects OB1 and OB2 shown in FIG. 9A represent subject images contained in the captured scene. The viewing directions of the two virtual cameras 60L, 60R are set to aim at the object OB1 in the illustrated example (FIG. 9A). For the sake of explanation, each image captured by the virtual camera 60L is depicted by parallel vertical lines while each image captured by the virtual camera 60R is depicted by parallel horizontal lines in FIG. 9B.

The images stored in the image storage blocks 162L, 162R are synthesized and then the monitor 11 displays a synthesized image. As will be discussed later, the monitor 11 is provided with a sheetlike parallax barrier member 71 attached to a screen surface. The parallax barrier member 71 may be an optical device supplied from Arisawa Manufacturing Ltd. under the brand name Xpol (registered trademark), for example. Referring to FIG. 10, the parallax barrier member 71 is a device configured with a number of fine polarizing strips which are arranged in a regular pattern including vertically polarizing zones in which vertically oriented slits are formed as well as horizontally polarizing zones in which horizontally oriented slits are formed, the vertically polarizing zones and the horizontally polarizing zones being alternately arranged at specific intervals (each corresponding to the width of a single horizontal scanning line) in a vertical direction. With the parallax barrier member 71 thus configured, the vertically polarizing zones permit only vertically polarized light contained in an optical image emitted from the monitor 11 to pass through, whereas the horizontally polarizing zones permit only horizontally polarized light contained in the optical image from the monitor 11 to pass through (refer to FIG. 9B). A pair of glasses 72 includes left and right eyeglasses to which fine polarizing films (polarizers) for the vertically polarized light and the horizontally polarized light are attached, respectively, wherein the left eyeglass permits only the vertically polarized light to pass through and the right eyeglass permits only the horizontally polarized light to pass through. Thus, as the player wearing the pair of glasses 72 watches polarized optical images on the monitor 11 that produce parallax to his or her left and right eyes, the player is given stereoscopic vision and can see a 3D image which gives a stereoscopic feeling.

More specifically, referring to FIG. 10, the virtual cameras 60L, 60R perform repetitive image pickup operations at specific time intervals, or at 1/60 second intervals, for example, and images captured at each successive timing are temporarily written in the respective image storage blocks 162L, 162R. The image storage blocks 162L, 162R each have a storage capacity for n lines (horizontal rows of pixels) arranged in a vertical direction by m columns arranged in a horizontal direction, while a video RAM 162c has a storage capacity for 2n lines arranged in the vertical direction by m columns arranged in the horizontal direction.

The image display controller 161c includes a read/write address controller 161c-1 which reads out image data from each successive line of the image storage block 162L and writes the same in an odd-numbered line of the video RAM 162c. After writing image data in one odd-numbered line of the video RAM 162c, the read/write address controller 161c-1 reads out image data from one line of the image storage block 162R and writes the same in an even-numbered line of the video RAM 162c. The read/write address controller 161c-1 repeats this read/write sequence for one line of the video RAM 162c after another until the image data is written successively in the 1st to 2nth lines of the video RAM 162c. To carry out this read/write sequence, the read/write address controller 161c-1 successively creates read addresses and write addresses and generates a chip select signal. Upon completion of the aforementioned read/write sequence, the video RAM 162c holds the image data necessary for generating left- and right-eye images.

The image data thus stored in the video RAM 162c is successively read out and sent to the monitor 11 at a specific high speed. The monitor 11 has the same number of pixels as the video RAM 162c, that is, 2n by m pixels. As shown pictorially in FIG. 10, the parallax barrier member 71 has the fine polarizing strips forming the vertically polarizing zones for passing only the vertically polarized light and the fine polarizing strips forming the horizontally polarizing zones for passing only the horizontally polarized light and, as already mentioned, the vertically polarizing zones (depicted by parallel vertical lines) and the horizontally polarizing zones (depicted by parallel horizontal lines) are alternately arranged in the vertical direction at specific intervals that correspond to the width of each successive horizontal line, or each row of pixels.

Meanwhile, the aforementioned arrangement of the embodiment described with reference to FIGS. 9A, 9B and 10 may be modified such that the image storage blocks 162L, 162R for storing the images captured by the virtual cameras 60L, 60R each have a storage capacity for 2n lines arranged in the vertical direction. According to the arrangement thus modified, the image storage blocks 162L, 162R each have the same number of lines (horizontal rows of pixels) arranged in the vertical direction as the monitor 11 and, therefore, it is possible to produce in the 3D display mode a 3D image having as high a resolution as achieved in the 2D display mode. Also, the aforementioned arrangement of the embodiment may be so modified as to read out the data content of the image storage blocks 162L, 162R and output the same directly to the monitor 11 instead of once writing the image data in the video RAM 162c. This modification involving synchronized read and output operations will make it possible to devise an arrangement which does not require the video RAM 162c to be provided.

The foregoing discussion has dealt with a case where the virtual cameras 60L, 60R are located at two different positions with a prescribed positional relationship therebetween for the 3D display mode. Described now in the following is a case where the 2D display mode is selected.

If the display mode specifier 161j outputs a command signal for display mode switching from the 3D display mode to the 2D display mode, the virtual camera controller 161d controls the virtual cameras 60L, 60R so that the positions and viewing directions thereof coincide with each other. Consequently, the two virtual cameras 60L, 60R capture the same image and, thus, the image storage blocks 162L, 162R stores the same image data. Further, the image data is written in the individual lines of the video RAM 162c by essentially the same procedure (read/write sequence) as used in the 3D display mode. Since images presented on the monitor 11 for the left and right eyes no longer produce parallax in this case, the combined image will not give the player wearing the pair of glasses 72 any stereoscopic feeling, which is a “normal” state of on-screen presentation where a 3D image is presented in the 2D display mode. If the display mode specifier 161j outputs a command signal for display mode switching from the 2D display mode to the 3D display mode, on the contrary, the virtual camera controller 161d sets the virtual cameras 60L, 60R at separate positions having the prescribed positional relationship therebetween and, as a result, parallax is created for the left and right eyes, making it possible to give a stereoscopic feeling. The above-described approach makes it possible to switch the on-screen presentation between the 2D display mode and the 3D display mode by simply performing an operation for altering the positions of the two virtual cameras 60L, 60R. The control program that permits execution of such display mode switching operation is stored in advance in the ROM 163.

The virtual camera controller 161d sets the positions of the virtual cameras 60L, 60R that determine the positional relationship therebetween in a manner described below. Specifically, the left and right virtual cameras 60L, 60R are set at positions offset left and right by a specific distance from a reference point (central point) defined according to position information which is controlled based on the assumption that there is provided only one virtual camera. Images captured by the virtual cameras 60L, 60R will be more natural if the distance between the virtual cameras 60L, 60R is made generally equal to the distance between two human eyes, and it is preferable to so position the virtual cameras 60L, 60R. In one varied form of the embodiment, the positions of the virtual cameras 60L, 60R may be determined using the position of one virtual camera 60 as a reference point.

Returning to FIG. 4, the RAM 162 of the control section 16 is configured to include an in-process information storage block 162a for storing constantly updated in-process game information which contains operational information produced by all of the players playing a shooting game in the same virtual game space, the players including the primary player and the friend and foe players whose operational information is obtained through the network communication section 18, as well as a setup information storage block 162b for storing setup information and point information concerning settings and operations made by the players by manipulating various switches and buttons. Each time the shooting game is finished, the communication controller 161m transmits the point information to the server 3 together with the player's user ID and the identification information related to the gaming terminal 1 and an arcade game parlor.

The game-related image display specifier 161k issues a command and performs a relevant operation for presenting game-related information on the monitor 11. The game-related information which may be presented on-screen includes, for example, balloon images and various kinds of text information as well as various kinds of item images to be gained by each player. These images and information are displayed in the form of panel images in this embodiment.

Depicted in FIG. 11 is an example of a TPS image of a competitive scene displayed on the monitor 11 that represents, in particular, a situation where a foe character P21 has appeared in front of a character P11 of the primary player who aims his or her gun and a character P12 of a friend player. Also presented in the image of FIG. 11 are an item image Q1 and a ballooned voice message image Q2.

The ROM 163 includes a game-related image storage block 163a which serves to store the aforementioned balloon images and various kinds of text information (voice messages) as well as various kinds of item images to be gained by each player. Game-related images are presented in the form of panel images which may include objects and textures. There may be provided only one kind of ballooned message or a specific kinds of ballooned messages. The text information may include texts of voice messages produced primarily by the primary player when telling or asking a friend player a current status of the game or drawing a friend player's attention in a case where the status of the game has reached a predefined situation. The voice message that the primary player will produce when the foe character P21 has appeared would be “Take care! Enemy is there!” as shown in FIG. 11, for example. The game-related image display specifier 161k automatically selects an appropriate voice message according to the status of the game and presents the voice message in the form of a balloon image on the monitor 11. Each of such voice messages may be stored in a form combined with or contained in a balloon. Also, items offered as options may include such weapons as a rifle, a handgun, other kinds of hand-operated weapons like a knife and a hand grenade, and so forth.

Individual panel images are prepared as data usable for creating images adapted to three-dimensional viewing. Three-dimensional image presentation is accomplished by the image display controller 161c. Specifically, the game-related image storage block 163a stores the aforementioned objects and textures as well as address information used for pasting the textures at positions slightly offset from the objects. The panel images are stored separately for each individual scene or as partial images. Images for the left and right eyes are created by slightly offsetting the textures from the objects, thereby allowing for three-dimensional viewing. Meanwhile, it is not necessary to offset all the textures from the relevant objects by an amount corresponding to the same number of addresses but may be offset by slightly varied amounts depending on images of gaming scenes presented on-screen. This will produce different levels of game playing sensation. For example, compared to the voice message image containing the message “Take care! Enemy is there!”, voice message images for the left and right eyes containing the message “Take care! Enemy is aiming at you!” may be offset by an amount corresponding to a larger number of addresses in order to present the message with more emphasized three-dimensional (stereoscopic) effect.

Items which may be displayed on the monitor 11 are selected as follows. Specifically, when the player's own character is in a particular situation during the progress of a game, the game-related image display specifier 161k makes a decision on which items are now obtainable by the player and selects one or all of the available items as options. In the example of FIG. 11, a three-dimensional image of a machine gun is presented near a lower right corner of the display screen of the monitor 11. In one aspect of the embodiment, the items may be prepared not only as 3D images but also as 2D images and items that are unobtainable in the current situation may be displayed together with the obtainable items in a manner distinguishable therefrom.

The image display controller 161c is configured to write a specified panel image by overwriting the same in the video RAM 162c in which the image data read out from the image storage blocks 162L, 162R are already written. As a result of this overwriting operation, a hidden surface elimination process is executed with first priority given to an item which has been overwritten so that each item overwritten remains always visible. The size of each balloon image and of each text (voice message) may be determined as a size suited for presenting a projected image depending on the distance between the character in question and the virtual camera pair 60. The embodiment may employ such an arrangement that individual on-screen images for the left and right eyes are written in the image storage blocks 162L and 162R, respectively.

The player can obtain a desired item displayed in a three-dimensional form by performing a prescribed operation for specifying the relevant item and thereby allocate the item to himself or herself as a ready-to-use virtual weapon. The item thus obtained by the player become ready to use from this point in time and remains usable even in a next game by updating relevant information held in the server 3 upon completion of the current game.

The communication controller 161m transmits contents of a command made by the game-related image display specifier 161k to the gaming terminal 1 operated by each friend player through the network communication section 18 and receives contents of a command made by the game-related image display specifier 161k of the gaming terminal 1 operated by each friend player through the network communication section 18. Upon receiving the contents of the command made by the game-related image display specifier 161k of the gaming terminal 1 operated by a friend player through the network communication section 18, the image display controller 161c displays the ballooned voice message image Q2 on the player's own monitor 11 in association with the friend player's character who has produced the relevant voice message. This makes it possible to recognize which character has produced the voice message “Take care! Enemy is there!”, for example. In a case where the friend player is located behind the primary player and invisible, the image display controller 161c may simply display the voice message alone and not the friend player's character. As it is possible to assign identification information to each of the characters of friend and foe players based on identification information assigned to the gaming terminals 1 operated by the respective players and player identification information assigned thereto, it will be possible to enable the primary player to recognize which player's character has produced the voice message by assigning some kind of identification information to each of the friend and foe players even if these are invisible.

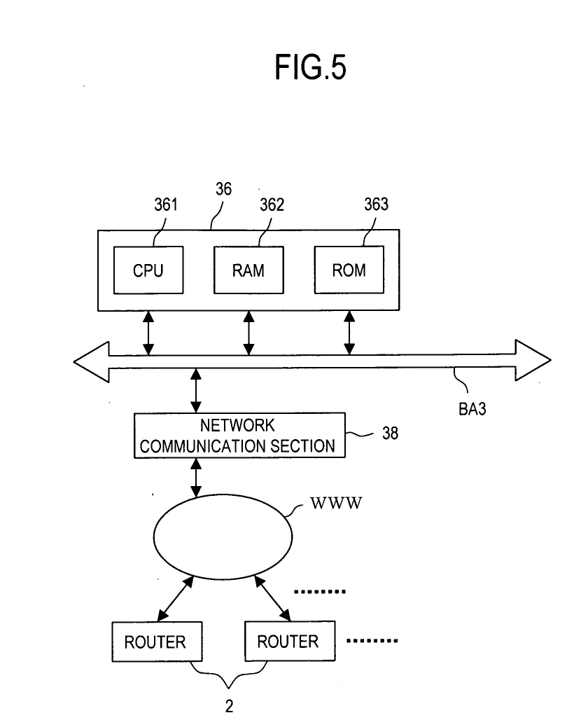

FIG. 5 is a hardware configuration diagram of the server 3 according to the present embodiment. The server 3 is provided with a control section 36 for controlling overall operation of the server 3, the control section 36 including a CPU 361 serving as an information processor, a RAM 362 for temporarily storing the player's personal information and game-related information regarding each player, for instance, and a ROM 363 in which prescribed image information for management purpose and a management program are stored in advance.

Among various kinds of data stored in the ROM 363, data stored in a removable storage medium may be made readable by such a drive as a hard disk drive, an optical disc drive, a flexible disk drive, a silicon disk drive or a cassette medium reading device, for example. In this case, a suitable storage medium is a hard disk, an optical disc, a flexible disk, a CD, a DVD or a semiconductor memory, for example.

A network communication section 38 also provided in the server 3 performs transmission and reception of various kinds of data to and from any specified one of the gaming terminals 1 according to terminal identification information through a network like the Worldwide Web (abbreviated WWW) and one of the routers 2.

The management program stored in the ROM 363 is loaded into the RAM 362 and the CPU 361 executes a game progress program held in the RAM 362 to perform functions successively activated by running the game progress program.

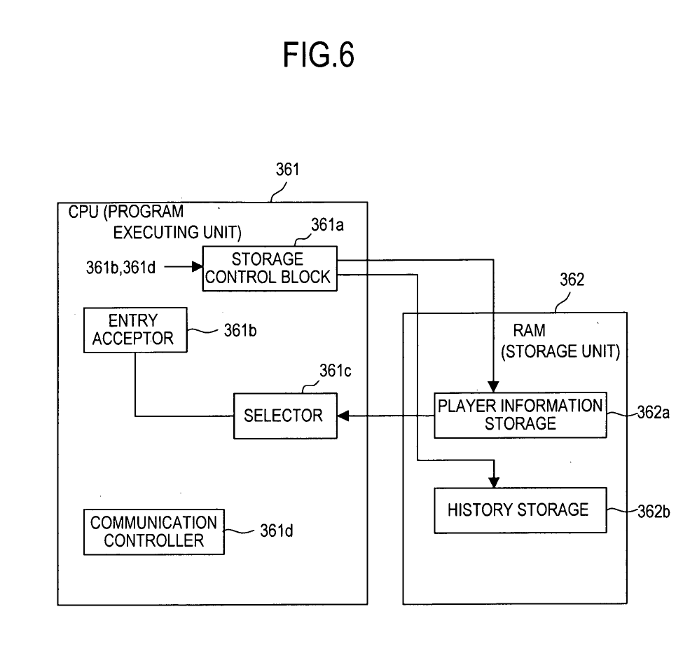

FIG. 6 is a functional configuration diagram of the control section 36 of the server 3. The RAM 362 of the control section 36 is configured to include a player information storage block 362a for storing such personal information as the user ID and a history storage block 362b for storing a constantly updated history of game scoring information (game results) of the individual players.

The CPU 361 of the control section 36 serves as a plurality of functional blocks including a storage control block 361a which controllably records individual kinds of information in the player information storage block 362a and the history storage block 362b, an entry acceptor 361b which performs a sequence of entry acceptance management operation for accepting participation of a player in a game as a result of acceptance of the player's entry into the game at each of the gaming terminals 1, a selector 361c which determines a combination of specified numbers of players (e.g., 2 or 4 players each on the friend and foe sides) who are selected to play the game in the same virtual game space from among the players accepted by the entry acceptor 361b according to a later-described rule, and a communication controller 361d which controls exchanges of information to and from the individual gaming terminals 1.

The entry acceptor 361b receives such personal information as the player's user ID and the identification information related to the gaming terminal 1 and an arcade game parlor transmitted from one of the gaming terminals 1 and then admits the player to the game.

In addition, the entry acceptor 361b issues a command for defining a combination of competing players to the selector 361c if any player(s) is (are) scheduled to participate in a competitive game. The selector 361c selects players who will play a game in the same game space according to predefined conditions (or the rule). Generally, the selector 361c selects participating players in the order of entry acceptance, for example. It is also preferable for the selector 361c to give priority to players accepted in the same arcade game parlor and allocate these players in the same game space. As an example, the selector 361c regards players participating almost simultaneously from the same arcade game parlor as friends and, thus, allocates these players in the same game space as friend players. If the number of friend players does not reach a prescribed number (e.g., 2 players versus 2 players or 4 players versus 4 players in each game in this embodiment), the selector 361c may select one or more players who wish to participate in the game from other game parlor(s). The selector 361c may also select a group of foe players in a manner similar to what has been described above.

An alternative arrangement which may be used when a plurality of players are willing to participate in a shooting game would be to allow one of the players to indicate that those players wish to play in a group of friend players at one of the gaming terminals 1 (or a “master terminal”) in an arcade game parlor that has first accepted the player's entry. This arrangement will enable the simultaneously participating players to play as members of a friend player group in a reliable fashion.

After the selector 361c has established a linkage between each participating player and the virtual game space, the entry acceptor 361b transmits information concerning this linkage to the gaming terminal 1 at which the entry of the pertinent player has been accepted. Also, the server 3 is configured such that the communication controller 361d thereof transmits player information concerning each player to the gaming terminals 1 operated by the other participating players when all the players have been linked to the virtual game space, the player information including at least the identification information concerning the gaming terminal 1 operated by each player and the arcade game parlor where that gaming terminal 1 is installed. This arrangement allows the individual player's gaming terminals 1 to exchange the operational information.

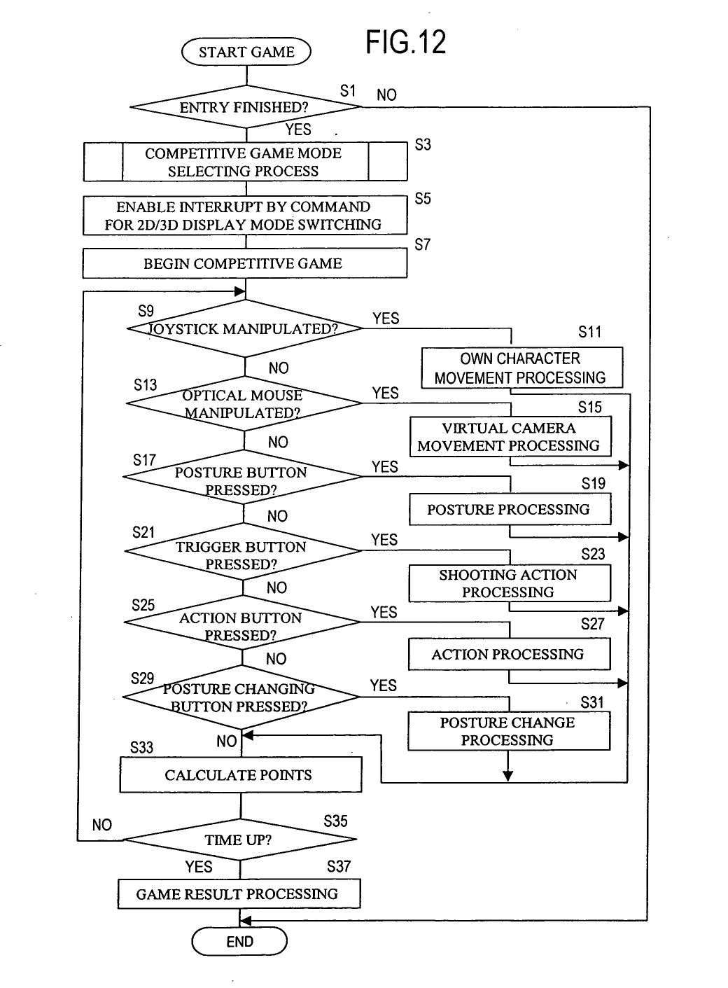

FIG. 12 is a flowchart illustrating a game processing procedure carried out by the CPU 161 of the gaming terminal 1 according to the game program. First, the CPU 161 judges whether an entry acceptance process has finished (step S1). If the entry acceptance process is judged unfinished yet (No in step S1), the CPU 161 exits the operational flow of FIG. 12. If the entry acceptance process is judged already finished (Yes in step S1), on the other hand, the CPU 161 performs a competitive game mode selecting process when a competitive game mode select button displayed on the monitor 11 is pressed, for example (step S3).

Upon completion of competitive game mode selection and other necessary settings, if any, in step S3, the gaming terminal 1 allows the player to play a competitive game. At this point in time the CPU 161 permits an interrupt by a command signal for switching the gaming terminal 1 between the 2D and 3D display mode (step S5). The player can now begin playing the game at the gaming terminal 1 (step S7).

From this time onward, the CPU 161 cyclically performs the below-described sequence (steps S9-S33) to proceed with the competitive game in this embodiment. Specifically, the CPU 161 judges whether the player has manipulated the joystick 41 (step S9). If the judgment result in step S9 is in the negative, the CPU 161 judges whether the player has manipulated the optical mouse 31 (step S13). If the judgment result in step S13 is in the negative, the CPU 161 judges whether the player has pressed the posture button 42 (step S17). If the judgment result in step S17 is in the negative, the CPU 161 judges whether the player has pressed the trigger button 32 (step S21). If the judgment result in step S21 is in the negative, the CPU 161 judges whether the player has pressed the action button 44 (step S25). If the judgment result in step S25 is in the negative, the CPU 161 judges whether the player has pressed the posture changing button 33 (step S29). Then, if the judgment result in step S29 is in the negative, the CPU 161 causes the point processor 161i to perform an operation for calculating points gained by the player (step S33). In a case where all of the judgment results in the aforementioned decision blocks (steps S9, S13, S17, S21, S25, S29) are in the negative, the CPU 161 passes the point calculating operation of step S33.

If the judgment results in the aforementioned decision blocks (steps S9, S13, S17, S21, S25, S29) are in the affirmative, the CPU 161 performs the below-described operations (steps S11, S15, S19, S23, S27, S31), respectively. Specifically, if the joystick 41 is judged to have been manipulated in step S9, the CPU 161 initiates an operation for processing movement of the player's own character (step S11). If the optical mouse 31 is judged to have been manipulated in step S13, the CPU 161 initiates an operation for moving the virtual cameras 60L, 60R (step S15). If the posture button 42 is judged to have been pressed in step S17, the CPU 161 initiates an operation for presenting a TPS image depicted in FIG. 11 with the virtual cameras 60L, 60R set at the “over-the-shoulder” position or, depending on previous settings, an FPS image as viewed generally from the muzzle position (step S19). If the trigger button 32 is judged to have been pressed in step S21, the CPU 161 initiates an operation for performing a shooting action (step S23). Further, if the action button 44 is judged to have been pressed in step S25, the CPU 161 initiates an operation for causing the player's own character to perform a direct combat action (step S27). Additionally, if the posture changing button 33 is judged to have been pressed in step S29, the CPU 161 initiates an operation for changing the posture of the player's own character (step S31). The CPU 161 causes the point processor 161i to perform the point calculating operation and subtracting operation, if necessary, (step S33) each time one of steps S11, S15, S19, S23, S27 and S31 described above has been carried out. The CPU 161 carries out each game by performing the above-described steps in accordance with the player's operations under the control of the game program.

Subsequently, the CPU 161 judges whether or not a “time up” situation has been reached after a lapse of a specific game playing time by use of an internal timer (not shown) (step S35). If the “time up” situation has not been reached yet, the CPU 161 returns to step S9. If the “time up” situation has already been reached, on the other hand, the CPU 161 performs various game result processing operations (step S37). The CPU 161 finishes the above-described game processing procedure at this point.

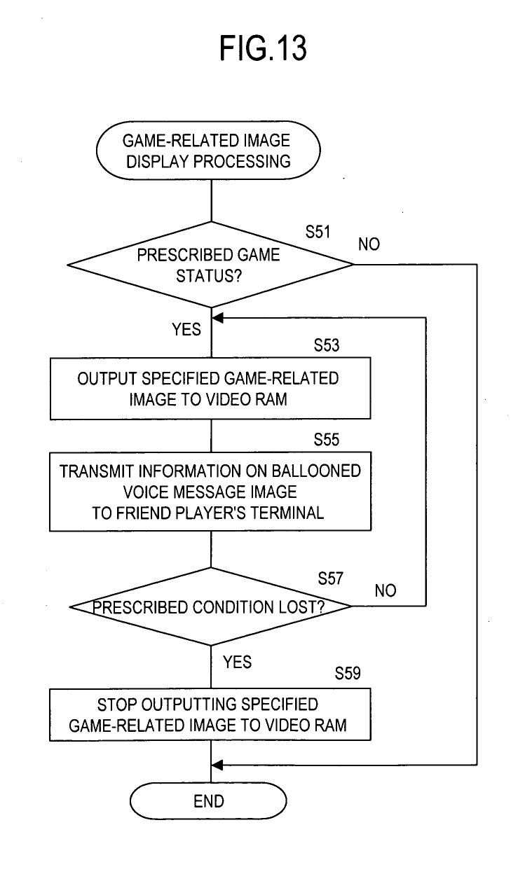

FIG. 13 is a flowchart illustrating a game-related image display processing procedure carried out by the CPU 161 of the gaming terminal 1 according to the game program. First, the game-related image display specifier 161k of the CPU 161 judges whether the game in progress has reached a prescribed game status (step S51). If the game is judged to have not reached the prescribed game status yet (No in step S51), the CPU 161 exits the operational flow of FIG. 13. If the game is judged to have already reached the prescribed game status (Yes in step S51), on the other hand, the CPU 161 proceeds to step S53. Here, the prescribed game status refers to a situation reached by the game where it is sufficiently possible to present the aforementioned panel images like ballooned voice message images and/or item images.

In step S53, the game-related image display specifier 161k reads out a specified panel image from the game-related image storage block 163a and outputs the same to the video RAM 162c in a manner suited for 3D image presentation. To be more specific, a texture corresponding to an object of the specified panel image is read out twice from storage locations of the game-related image storage block 163a offset from each other by a specific number of addresses and written into the video RAM 162c. Subsequently, the communication controller 161m transmits information on a ballooned voice message image Q2 to the gaming terminal 1 operated by each friend player (step S55). Thus, the ballooned voice message image Q2 is presented on the monitor 11 of the gaming terminal 1 operated by each friend player.

Next, the CPU 161 judges whether a prescribed condition has ceased to exist (step S57). If the prescribed condition still exist (No in step S57), the CPU 161 returns to step S53. If the prescribed condition has ceased to exist (Yes in step S57), on the other hand, the CPU 161 proceeds to step S59. For example, the prescribed condition refers to a predefined period of time in the case of the ballooned voice message image Q2, a predefined period of time or a period of time required for the player to obtain an item, whichever shorter, in the case of an item image.

In step S59, the game-related image display specifier 161k of the CPU 161 stops outputting the specified game-related image (panel image) to the video RAM 162c.

While the invention has thus far been described with reference to the preferred embodiment and specific arrangements thereof, the aforementioned arrangements of the embodiment are simply illustrative and may be modified in various ways. Cited under (1) to (6) below are some examples of such modifications of the embodiment.

(1) While the foregoing embodiment employs the first and second control pads 30, 40 adapted to playing a competitive game like a shooting game, the arrangement including the first and second control pads 30, 40 has been described simply as an illustrative example. In fact, the present invention is applicable to various kinds of games performed in a virtual game space in which a virtual camera is allowed to move in the virtual game space during the progress of the game in accordance with manipulation by a player, for instance. The kinds of games to which the invention is applicable include a combat game, competitive games like baseball and football games, other competitive games like a time trial, a mahjong game, a breeding game in which a player tries to “breed” characters.

(2) While the foregoing embodiment requires glasses as an essential components, it is possible to eliminate the need for glasses by employing glasses-free stereoscopic (3D) viewing systems like the parallax panoramagram or lenticular system, for example.

(3) Although an image for on-screen presentation in the 2D display mode is generated by using the image storage blocks 162L, 162R of the RAM 162 in essentially the same way as for 3D image presentation in the 3D display mode in the foregoing embodiment, this arrangement may be modified to use only one of the image storage blocks 162L, 162R instead of both, and successively read out image data from each successive line of the specified one of the image storage blocks 162L, 162R and output the same to the monitor 11. According to this modified arrangement, it is possible to accomplish 2D image presentation by using only one of the two image storage blocks 162L, 162R.

(4) Although the foregoing embodiment employs such an arrangement that data on individual gaming images captured by the two virtual cameras 60L, 60R are once written in the image storage blocks 162L, 162R, this arrangement may be modified so as not to employ the image storage blocks 162L, 162R but directly write the gaming image data obtained with the virtual cameras 60L, 60R in the successive lines of the video RAM 162c in alternate turns. In this modified arrangement, the video RAM 162c serves the earlier-described function of the image storage blocks 162L, 162R as well. Additionally, although successive lines (rows) of the images captured for the left and right eyes are arranged alternately in the successive lines of the video RAM 162c in the foregoing embodiment, the images may be stored alternately in one column and another.

Moreover, the foregoing embodiment may be modified to employ an arrangement in which the image storage blocks 162L, 162R each have a storage capacity corresponding to one-half the number of pixels of the monitor 11 and the virtual cameras 60L, 60R each have the capability to capture an image containing pixels corresponding to the number of pixels of the monitor 11. To be more specific, the arrangement thus modified may be such that odd-numbered lines (rows) of image data are successively read out from an image captured by the virtual camera 60L and written in lines 1 through n of the image storage block 162L, whereas even-numbered lines (rows) of image data are successively read out from an image captured by the virtual camera 60R and written in lines 1 through n of the image storage block 162R and, further, the image data held in the image storage block 162L is read and written in odd-numbered lines of the video RAM 162c which has a total of 2n lines, whereas the image data held in the image storage block 162R is read and written in even-numbered lines of the video RAM 162c. In order to generate an on-screen image in the 3D display mode with as high a resolution as achieved in the 2D display mode, it is not necessarily needed to match the storage capacity of the image storage blocks 162L, 162R to a level corresponding to the number of pixels of the monitor 11 but it is possible to achieve the same level of resolution by a signal processing technique if only the image data captured by the virtual cameras 60L, 60R contain the same number of pixels as the monitor 11.

(5) Although the foregoing embodiment is so configured as to present ballooned voice message (text information) images and/or item images as game-related images, the invention is not limited to this arrangement but is applicable to other arrangements which present various kinds of information concerning the progress or status of an on-going game. As an example, a video game machine of the invention may be so configured as to present the sum of points gained by the player's own character with a stereoscopic effect at an appropriate position on a display screen each time the player gains or looses his or her points during the progress of a game.

(6) The present invention is applicable to a video game machine which is configured to comprise a monitor having a display screen on which a parallax barrier member that permits three-dimensional viewing is provided, a communication processor which acquires game scores of individual players who have played a game, a game score processor associated with a pair of virtual score display panels for left and right eyes on which the game scores of the individual players are presented, wherein a distance in a left-to-right direction between images for the left and right eyes is set according to the game scores of the players, and an image display controller which presents the virtual score display panels for the individual players based on the distance between the images for the left and right eyes set for the individual players.

In summary, in one feature of the present invention, a video game machine is configured to present a player with a gaming image captured by at least one virtual camera within a view angle in a viewing direction thereof, the at least one virtual camera forming a combination of first and second virtual cameras having a capability to move within a virtual game space in accordance with manipulation by the player. This video game machine comprises a monitor having a display screen on which a parallax barrier member that permits three-dimensional viewing is provided, a virtual camera controller for moving the first and second virtual cameras while maintaining a positional relationship in which the first and second virtual cameras are separated by a prescribed distance from each other, an image display controller for synthesizing first and second image data acquired by the first and second virtual cameras upon leading the first and second image data to a display memory, and reading out data content of the display memory, a game-related image storage block for storing a plurality of kinds of panel images including objects and textures which are game-related images, and a specifier which issues a command for presenting at least one panel image during execution of a game, wherein the image display controller maps a texture corresponding to an object read out in accordance with the command given from the specifier twice in two storage locations of the display memory that are offset from each other by a specific number of addresses.

According to the video game machine, the gaming image display control method and the gaming image display program of the invention thus configured, a parallax barrier member that permits three-dimensional viewing is provided on the display screen of the monitor so that the player can the gaming image with a three-dimensional effect. Each virtual camera moves within the virtual game space in accordance with manipulation by the player. As the gaming image presented to the player on the monitor within the view angle in the viewing direction of each virtual camera, the player can move each virtual camera by manipulating an operating member while observing the on-screen gaming image. The virtual camera controller moves the first and second virtual cameras while maintaining a positional relationship in which the two virtual cameras are separated by a prescribed distance from each other in accordance with manipulation by the player. The image display controller synthesizes the first and second image data acquired by the first and second virtual cameras upon leading the first and second image data to the display memory and reads out the data content of the display memory and transmits the same to the monitor. Consequently, the monitor presents the gaming image captured by the first and second virtual cameras with the three-dimensional effect on a real-time basis. Also, the game-related image storage block stores a plurality of kinds of panel images including objects and textures which are game-related images. When the specifier issues a command for presenting at least one panel image during execution of a game, the image display controller generates a texture corresponding to an object read out in accordance with the command given from the specifier twice at locations offset from each other by a specific number of addresses, the texture are mapped twice in two storage locations of the display memory that are offset from each other. It follows that there is obtained a pair of panel images for the left and right eyes. Since the panel images are written in the display memory, overwriting the first and second image data acquired by the first and second virtual cameras which have already been written in the display memory, in the aforementioned manner, gaming images captured by the first and second virtual cameras and the previously prepared panel images are presented together on the same display screen of the monitor with a three-dimensional effect although in different ways.

In a gaming image displayed on-screen, objects to be presented are divided into two categories, that is, those objects whose appearance dynamically vary in accordance with manipulation of a controller by the player and those objects (e.g., objects, voice messages, pictograms, etc. displayed in a specific image) whose appearance do not dynamically vary. If the objects which do not vary dynamically are displayed in the form of virtual display panels arranged side by side representing images obtained by the left and right eyes together with previously offset textures, then it is possible to present the gaming images without jeopardizing the three-dimensional effect, yet suppressing computational preventing an increase in memory capacity required for generating three-dimensional images. Thus, it is possible to provide the player with gaming images producing compelling reality and enjoyable sensation in game playing with a reduced 3D processing burden.

In one aspect of the invention, the video game machine is preferably so configured that the image display controller causes the player's own character that is manipulated by the player to appear in the virtual game space and presents the player's own character on the monitor, and then presents the at least one panel image at a location related to a location where the player's own character is presented. According to this configuration, the panel image is presented at a location related to the location where the player's own character is presented. It is therefore possible to easily recognize with which characters individual panel images are associated even when a plurality of characters appear on-screen.

In another aspect of the invention, the video game machine is preferably so configured that the panel images include a plurality of kinds of text information prepared in advance and balloon images for presenting the individual kinds of text information, and the specifier selects one of the plurality of kinds of text information in accordance with the progress of the game. According to this configuration, individual characters do not move aimlessly in accordance with manipulation by a pertinent player but each character can be presented with a voice message. It is therefore possible to present each player's character with various pieces of information concerning the progress of the game. This makes each game more enjoyable with more humanlike characters presented on-screen.

In still another aspect of the invention, the video game machine is preferably so configured that the panel images include a plurality of kinds of item images prepared in advance and the specifier selects such item images that are selectable by the player's own character in accordance with the progress of the game. Since individual items are displayed three-dimensionally even during the execution of a game in this configuration, the player can easily recognize a desired item that is selectable for his or her own use.

In yet another feature of the present invention, a network game system comprises a plurality of video game machines that are interconnected by a network and divided into at least two groups of video game machines operated by friend and foe players to allow the players to play a group fighting game, each of the video game machines further comprising a communication processor for exchanging operational information among the plurality of video game machines, wherein the communication processor enables each of the video game machines to transmit and receive the panel images to and from only those video game machines which are operated by the friend players, and the image display controller maps a texture corresponding to an object of a panel image received through the communication processor twice in two storage locations of the display memory that are offset from each other by a specific number of addresses. According to the network game system thus configured, the individual player's characters are presented with panel images and, in particular, with ballooned text information (voice messages) in the friend player's video game machines, and this serves to enhance teamwork among the friend players and make each game more interesting and exciting.

1. A video game machine configured to present a player with a gaming image captured by at least one virtual camera within a view angle in a viewing direction thereof, said at least one virtual camera forming a combination of first and second virtual cameras having a capability to move within a virtual game space in accordance with manipulation by the player, said video game machine comprising:
a monitor having a display screen on which a parallax barrier member that permits three-dimensional viewing is provided;
a virtual camera controller for moving said first and second virtual cameras while maintaining a positional relationship in which said first and second virtual cameras are separated by a prescribed distance from each other;
an image display controller for synthesizing first and second image data acquired by said first and second virtual cameras upon leading the first and second image data to a display memory, and reading out data content of said display memory;
a game-related image storage block for storing a plurality of kinds of panel images including objects and textures which are game-related images; and
a specifier which issues a command for presenting at least one panel image during execution of a game;
wherein said image display controller maps a texture corresponding to an object read out in accordance with the command given from said specifier twice in two storage locations of said display memory that are offset from each other by a specific number of addresses.

2. The video game machine according to claim 1, wherein said image display controller causes the player's own character that is manipulated by the player to appear in the virtual game space and presents the player's own character on said monitor, and then presents the at least one panel image at a location related to a location where the player's own character is presented.

3. The video game machine according to claim 1, wherein the panel images include a plurality of kinds of text information prepared in advance and balloon images for presenting the individual kinds of text information, and said specifier selects one of the plurality of kinds of text information in accordance with the progress of the game.

4. The video game machine according to claim 1, wherein the panel images include a plurality of kinds of item images prepared in advance and said specifier selects such item images that are selectable by the player's own character in accordance with the progress of the game.

5. A gaming image display method for a video game machine which comprises a monitor, a virtual camera controller, an image display controller, a game-related image storage block and a specifier, said monitor having a display screen on which a parallax barrier member that permits three-dimensional viewing is provided, said video game machine being configured to present on said monitor a gaming image captured by at least one virtual camera within a view angle in a viewing direction thereof, said at least one virtual camera forming a combination of first and second virtual cameras having a capability to move within a virtual game space in accordance with manipulation of an operating member by a player, said gaming image display control method comprising the steps of:
causing said virtual camera controller to move said first and second virtual cameras while maintaining a positional relationship in which said first and second virtual cameras are separated by a prescribed distance from each other;
causing said image display controller to synthesize first and second image data acquired by said first and second virtual cameras upon leading the first and second image data to a display memory and to read out data content of said display memory;
causing said game-related image storage block to store a plurality of kinds of panel images including objects and textures which are game-related images;
causing said specifier to issue a command for presenting at least one panel image during execution of a game; and
causing said image display controller to map a texture corresponding to an object read out in accordance with the command given from said specifier twice in two storage locations of said display memory that are offset from each other by a specific number of addresses.

6. A gaming image display program for a video game machine which comprises a monitor having a display screen on which a parallax barrier member that permits three-dimensional viewing is provided, said video game machine being configured to present on said monitor a gaming image captured by at least one virtual camera within a view angle in a viewing direction thereof, said at least one virtual camera forming a combination of first and second virtual cameras having a capability to move within a virtual game space in accordance with manipulation of an operating member by a player, said gaming image display program being configured to cause said video game machine to perform functions comprising:
a virtual camera controller for moving said first and second virtual cameras while maintaining a positional relationship in which said first and second virtual cameras are separated by a prescribed distance from each other;
an image display controller for synthesizing first and second image data acquired by said first and second virtual cameras upon leading the first and second image data to a display memory, and reading out data content of said display memory;
a game-related image storage block for storing a plurality of kinds of panel images including objects and textures which are game-related images; and
a specifier which issues a command for presenting at least one panel image during execution of a game;
wherein said image display controller maps a texture corresponding to an object read out in accordance with the command given from said specifier twice in two storage locations of said display memory that are offset from each other by a specific number of addresses.

7. A network game system comprising a plurality of video game machines according to claim 1 that are interconnected by a network and divided into at least two groups of video game machines operated by friend and foe players to allow the players to play a group fighting game, each of said video game machines further comprising a communication processor for exchanging operational information among said plurality of video game machines, wherein said communication processor enables each of said video game machines to transmit and receive the panel images to and from only those video game machines which are operated by the friend players, and said image display controller maps a texture corresponding to an object of a panel image received through said communication processor twice in two storage locations of said display memory that are offset from each other by a specific number of addresses.

8. A network game system comprising a plurality of video game machines according to claim 2 that are interconnected by a network and divided into at least two groups of video game machines operated by friend and foe players to allow the players to play a group fighting game, each of said video game machines further comprising a communication processor for exchanging operational information among said plurality of video game machines, wherein said communication processor enables each of said video game machines to transmit and receive the panel images to and from only those video game machines which are operated by the friend players, and said image display controller maps a texture corresponding to an object of a panel image received through said communication processor twice in two storage locations of said display memory that are offset from each other by a specific number of addresses.

9. A network game system comprising a plurality of video game machines according to claim 3 that are interconnected by a network and divided into at least two groups of video game machines operated by friend and foe players to allow the players to play a group fighting game, each of said video game machines further comprising a communication processor for exchanging operational information among said plurality of video game machines, wherein said communication processor enables each of said video game machines to transmit and receive the panel images to and from only those video game machines which are operated by the friend players, and said image display controller maps a texture corresponding to an object of a panel image received through said communication processor twice in two storage locations of said display memory that are offset from each other by a specific number of addresses.
